(19) United States
(12) Patent Application Publication
(10) Pub. No.: US 2005/0252314 A1
(43) Pub. Date: Nov. 17, 2005

(54) Measuring device for the analysis of liquids and/or gases

(76) Inventors: Axel Vierkotter, Rutesheim (DE); Detley Wittmer, Maulbronn (DE)

Correspondence Address: BACON & THOMAS, PLLC, 625 SLATERS LANE, FOURTH FLOOR, ALEXANDRIA, VA, 22314, US

(21) Appl. No.: 10/509,750

(22) PCT Filed: Apr. 10, 2003
(86) PCT No.: PCT/EP03/03720

§ 371 Date: May 18, 2005

(30) Foreign Application Priority Data
Apr. 12, 2002 (DE) 102 16 379.0

(51) Int. Cl. G01D 7/02

(52) U.S. Cl. 73/866.1

(57) ABSTRACT

A measuring device for the conditioning, output and forwarding of sensor signals in the context of a liquid and/or gas analysis. The measuring device includes a housing of an electrically conductive material, in a wall of the housing at least one cable gland for a shielded sensor signal line for the transmission of the sensor signals, and an electrically conductive connection between a shielding of the sensor signal line and the housing. In order to make the measuring device as insensitive as possible to interferences and thereby to improve the accuracy and reliability of the measuring device each cable gland has regions of an electrically conductive material and means for the electrical contacting of the regions both with the shielding of the sensor signal line and with the housing and the regions serve for creating an electrically conductive connection between the shielding of the sensor signal line and the housing. Preferably, the body of the cable gland is made of metal. Additionally, it is provided that all circuit portions of the measuring device are decoupled using optocouplers or converters.

The present invention relates to a measuring device for preparing, outputting and forwarding of sensor signals in the context of liquid and/or gas analysis. The measuring device includes a housing of an electrically conductive material, at least one cable lead-through, or gland, in a wall of the housing for a shielded sensor signal line carrying the sensor signal, and an electrically conductive connection between a shielding of the sensor signal line and the housing.

Such a measuring device is also referred to as a transmitter. A sensor, for example a pH-sensor or a temperature sensor, for instance one extending into a liquid, is provided for connection to the measuring device. The raw data measured by the sensor is first preprocessed by a sensor circuit of the measuring device, in, order that it can be sent as measurement data to a computing unit of the measuring device.

The preprocessing in the sensor circuit includes especially one or more of the following processing steps:
an analog preprocessing of the raw data,
an analog/digital conversion, and
a digital preprocessing.

The actual processing of the sensor signals is then carried out in the computing unit. The computing unit is e.g. a microprocessor, in which a suitable computer program is executed for the processing of the measurement data. The computing unit can display the measurement data e.g. on a connected monitor or forward it over a connected, external communications system to other control and/or monitoring equipment.

The computer program stored in the computing unit includes a multiplicity of program commands, which serve for the processing of the received measurement data. Thus, it is possible, for example, to convert the measurement data in the computing unit with the help of the program commands. Likewise, it is possible to rid the measurement data of e.g. sensor-dependent fluctuations by means of the program commands in the computing unit; for instance, the fluctuations can be averaged. Overall, the program commands help to achieve that the measurement data can, as already mentioned, be issued to the monitor or forwarded over the external communications system.

The raw data registered by the sensors is forwarded over shielded sensor signal lines to the measuring device and processed there. The shielding of the sensor signal lines includes, for example, an external braid of an electrically conductive material, especially metal, which extends in the axial direction about the actual line.

The sensor signals transmitted over the sensor signal lines are extremely sensitive to interference. Interferences of the sensor signals can be caused, for example, by pumps and other machines of heavy industry, when the measuring device is installed in the vicinity of such machines. The sensitivity of the sensor signals is especially a result of the very small size of the sensor signals, in the pico-ampere range, or the high resistance of the sensor signal lines, as the case may be.

In order to prevent interference, respectively in order to minimize the effect of interferences on the sensor signals, various measures are known in the state of the art. For example, the shielding of the sensor signal lines can be grounded (so-called process ground).

For this purpose, it is known to direct the sensor signal lines via cable lead-throughs, or bushings, of plastic into the interior of the housing and to bare the shielding there, connect it with an end of a ground wire and to affix the other end of the ground wire to the housing. Ground wires do, however, have the disadvantage that they have high resistance and therefore interferences on the sensor lines can be conducted away only relatively poorly.

Overall, the result is that the sensor signals do get corrupted by the interferences that act on the sensor signal lines, which, in turn, corrupts the results of the liquid or gas analyses.

An object of the present invention is to embody and further develop a measuring device for liquid and/or gas analysis of the above-mentioned type such that the measuring device is as insensitive as possible to interferences, in order to improve thereby the accuracy and reliability of the measuring device.

This object is achieved according to the invention for a measuring device of the type mentioned above by providing the, or each, cable gland with regions of an electrically conductive material and means for the electrical contacting of the regions both with the shielding of the sensor signal lines and with the housing, and by having the regions serve for making the electrically conductive connection between the shielding of the sensor signal line and the housing.

The invention thus provides a measuring device having a low inductance coupling of the shielding of a sensor signal line to the housing, which is at ground (so-called process ground). Via the low inductance coupling, interferences on the sensor lines can be conducted away especially effectively directly through the housing to process ground.

In this way, interferences on the sensor signal lines can be minimized, this, in turn, leading to an increased accuracy of the measurement results of liquid and/or gas analyses.

The invention can, on the one hand, be realized by making the body of the cable gland out of an electrically insulating material (e.g. plastic), into which are introduced a plurality of grounding regions of an electrically conductive material (e.g. metal), via which the shielding of the sensor signal lines is placed in electrically conductive connection with the housing. The grounding regions are thus an integral part of the cable glands. The number and diameter of the grounding regions must be selected such that a low-inductance coupling of the shielding to the housing is assured. The contacting of the grounding regions with the shielding occurs preferably by suitable means provided in the cable gland. Such means includes e.g. a grounding sleeve of an electrically conductive material, which contacts the grounding region and which, following insertion of the cable gland into an opening in a housing wall, automatically comes into safe and reliable contact with the shielding of the sensor signal line upon screwing of the cable gland together.

In an advantageous further development of the present invention, the body of the, or each, cable gland is made of an electrically conductive material, preferably a metal. In this further development, therefore, there are not a plurality of separate grounding regions, but, instead, the entire body of the cable gland serves as one large grounding region.

In this way, an especially low-inductance coupling of the shielding to the housing can be achieved, along with an especially great insensitivity of the transmitter to interferences. A cable gland, whose body is made of metal, and which could be used within the framework of the present invention, is e.g. offered and sold by the firm Lapp Kabelsysteme GmbH, 70565 Stuttgart, Germany, under the product designation “Skindicht SHVE”.

In a preferred form of embodiment of the invention, in which the measuring device has a computing unit, especially a microprocessor, for processing the sensor signals and at least one sensor circuit in front of the computing unit for the preprocessing of the sensor signals, the, or each, sensor circuit is galvanically decoupled from the remainder of the measuring device. The galvanic decoupling assures that no interactions with respect to potentials exist between the sensor circuit and the remainder of the measuring device that could lead to a corruption of the measurement results. This feature leads, thus, to a decided improvement of the interference insensitivity and accuracy of the measuring device.

Also in the case of this transmitter having galvanic decoupling of the sensor circuits from the remaining measuring device, the shielding of the sensor lines is advantageously coupled with low inductance to the housing via a cable gland having electrically conductive grounding regions. The galvanic decoupling has the given advantages even without this feature from the body of claim 1. The patent protection is therefore to extend also to measuring devices of the last-mentioned kind, in which the features in the body of claim 1 are absent.

Especially expedient is the provision of optocouplers in the measuring device to accomplish the galvanic decoupling of the, or each, sensor circuit from the remainder of the measuring device. Optocouplers enable a safe and reliable galvanic decoupling to be implemented with relatively cost-favorable means.

According to another preferred form of embodiment of the invention, at least one power supply circuit is provided for the supply of the, or each, sensor circuit with energy, wherein the energy supply circuit has means for decoupling the measuring device from the power supply.

For the galvanic decoupling, preferably at least one transformer is applied, especially an AC/DC-converter.

Advantageously, the measuring device has at least two analog outputs, with the analog outputs being galvanically decoupled from one another.

Also in this case e.g. an optocoupler can be used for the galvanic decoupling. The transmitter can be connected via the analog outputs to other devices, e.g. to a programmable logic controller (PLC) The galvanic decoupling of the analog outputs prevents a coupling of the measuring device to the PLC.

Generalized, this means that, in the case of the measuring device of the present invention, various measures are provided, in order to decrease the susceptibility of the measuring device with respect to interferences. These measures include especially a low-inductance coupling of the shielding of the sensor signal lines to the housing of the measuring device, with the housing, in turn, itself being grounded (process ground), and a galvanic decoupling of various circuit portions of the transmitter, e.g. the sensor circuit, the power supply for the sensor circuit, and the analog outputs.

Additional features, possibilities of use, and advantages of the invention will become apparent from the following description of examples of embodiments of the invention, as shown in the drawing.

In this connection, all described or shown features, alone or in combination, form the subject of the invention, independently of their association in the patent claims or their origins, as well as independently of their formulation in the description or illustration in the drawing. The figures show as follows:

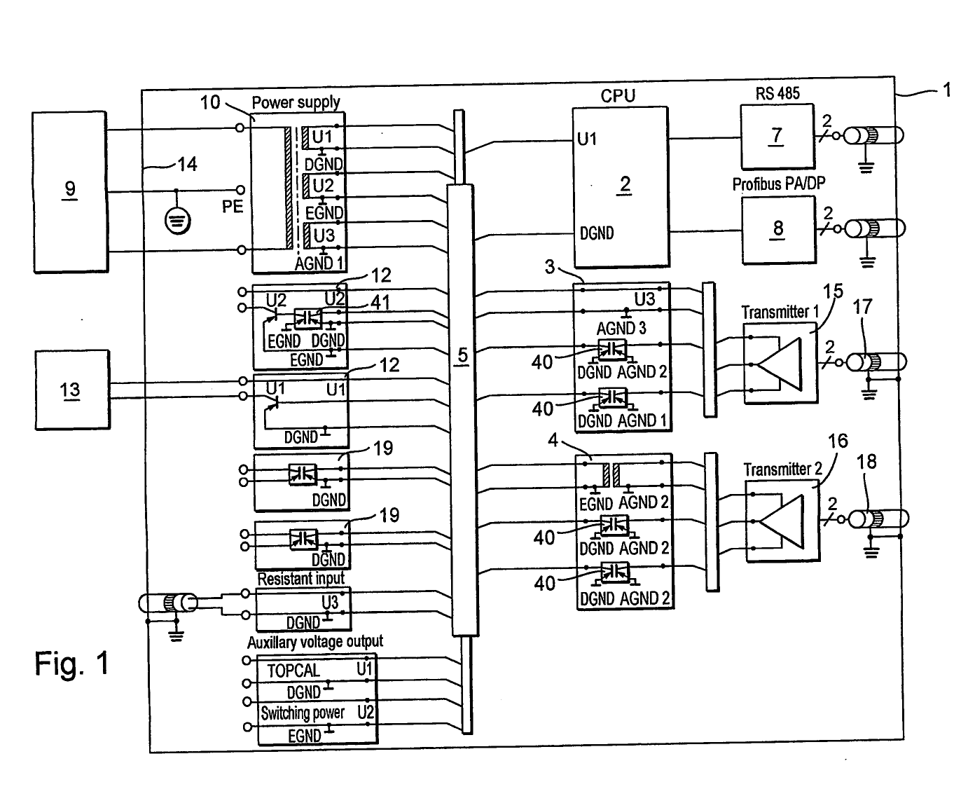

FIG. 1 a schematic block diagram of an example of an embodiment of a measuring device of the invention for liquid and/or gas analysis; and

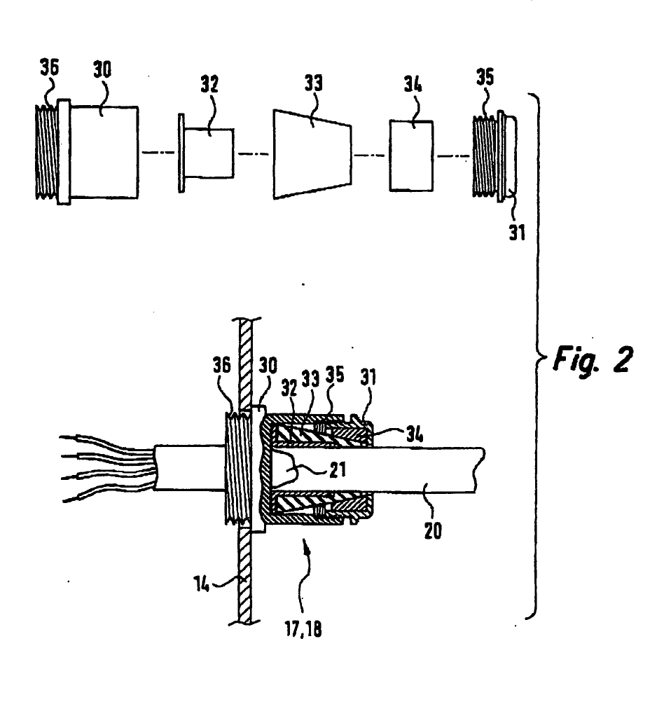

FIG. 2 an exploded view of a cable gland for use in the measuring device of the invention.

FIG. 1 designates indicates with reference numeral 1 a measuring device in its entirety. Measuring device 1 includes a computing unit 2, which is connected via isolation circuits 3, 4 with one or more sensor circuits 15, 16. The computing unit 2 is preferably implemented by means of a digital microprocessor. Sensors can be connected to the sensor circuits 15, 16 in manners not shown. The sensors can be e.g. a pH-sensor or a temperature sensor or a pressure sensor or the like.

The associated sensor circuits 15, 16 are then appropriately pH-sensor circuits or temperature sensor circuits or the like. The connection between the computing unit 2 and the isolation circuits 3, 4 is implemented by means of an internal bus system 5, which can be e.g. an I2C-bus and/or bus conductors for power supply voltages.

It is possible that only one of the sensor circuits 15, 16 and only the isolation circuit 3, 4 required therefor, and only one of the sensors are connected to the computing unit 2. Equally possible, however, is that any number of sensor circuits 15, 16, with the associated isolation circuits 3, 4 and sensors are connected with the computing unit 2. In the latter case, a control circuit, preferably a multiplexer, is provided in the computing unit 2. The control circuit helps to control the electrical connection between the computing unit 2 and the isolation circuits 3, 4 such that there is always only a single one of the sensor circuits 15, 16 connected with the computing unit 2. Preferably, the sensor circuits are connected with the computing unit in turn, one after the other.

Connected to the computing unit 2 is, among other things, at least one communications system 7, 8 for the connection of additional devices, e.g. a sequence controller or an access device. A sequence controller can include e.g. a calibrating system or a programmable logic controller (PLC). An access device is e.g. an external device, which can access the measuring device from the outside via a field bus system and change the internal conditions of the measuring device. In the case of the communications system 7, 8, it can be e.g. an interface according to the so-called HART-protocol, a serial interface (RS 485) 7, a so-called Profibus 8, a so-called Foundation Field Bus, or some other field bus.

Additionally connected to the measuring device 1 is at least one voltage supply 9. This can be an alternating voltage supply AC or a direct voltage supply DC. In the example, an alternating voltage supply 9 is provided, whose voltage is transformed galvanically separated (via a transformer) in a power supply circuit 10 into the desired direct voltage for supply of the individual circuit portions of the measuring device 1. The transformed voltage U1 is applied e.g. to the computing unit 2 and to an analog output 12, the transformed voltage U2 to another analog output 12, and the transformed voltage U3 to one of the sensor circuits 3.

Furthermore, an interface (not shown in FIG. 1) can be connected to the computing unit 2 for the use of an operating person. This interface can be e.g. a keyboard and/or a monitor. Add-ons 13 can be connected to the computing unit 2 via analog outputs 12 of the measuring device 1. These add-ons can be e.g. one or more additional displays or a programmable logic controller. Finally, e.g. setpoint values can be entered for the measuring device 1 over analog signal inputs 19.

The described sensor circuits 15, 16, the isolation circuits 3, 4, the external communications systems 7, 8, the power supply circuit 10, the interface and the analog outputs 12 represent hardware components of the measuring device 1, which are connected to the computing unit 2 or at least coupled therewith. For each of these hardware components, the computing unit is provided with a software module dedicated thereto.

The measuring device 1 includes a housing 14 of metal, which is grounded (so-called process ground). The sensors are connected to the sensor circuits 15, 16 by means of shielded signal lines 20. The sensor signal lines 20 are led into the interior of the housing 14 through cable glands 17, 18, which are arranged in a wall of the housing 14.

The construction of a cable gland 17, 18 will now be explained in greater detail on the basis of FIG. 2. The cable gland 17, 18 includes a lower part 30, which can be secured to an upper part 31 by means of a thread 35. Between the lower part 30 and the upper part 31 are a grounding sleeve 32, a sealing cone 33, and a chuck cone 34, which are immobilized in the interior of the cable gland 17, 18, when the lower part 30 is secured to the upper part 30. The body of the cable gland 17, 18, thus the lower part 30, the grounding sleeve 32, the chuck cone 34 and the upper part 31, are made of an electrically conductive material, especially metal. The sealing cone 33 is made of a rubber or synthetic material, e.g. neoprene. The grounding sleeve 32 is in electrically conductive connection with the body of the cable gland 17, 18. When the lower part 30 and upper part 31 are screwed together, the grounding sleeve 32 contacts the shielding 21 of a sensor signal line 20. When the cable gland 17, 18 is secured in an opening of the housing wall by means of a ring nut (not shown), which is screwed onto a thread 36, or when the lower part 30 is screwed directly into the metallic housing wall, the body of the cable gland 17, 18 contacts the housing 14. In this way, a low-inductance coupling of the shielding 21 of the sensor signal line 20 to the housing 14 occurs via the body of the cable gland 17, 18. In this way, interferences on the sensor signal lines 20 can be conducted away to process ground directly by way of the housing 14.

Additionally provided is that the sensor circuits 15, 16 are galvanically decoupled from the remainder of the measuring device 1 via optocoupler 40 in the isolation circuit 3, 4. Beyond this, the power supply circuit for supplying the sensor circuit 15 with the voltage U3 is decoupled by an AC/DC converter in the power supply circuit 10 from the power supply for the remaining circuit portions of the measuring device 1. The power supply circuit for supplying the sensor circuit 16 with voltage is decoupled from the power supply for the remaining circuit portions of the measuring device 1 by a DC/DC converter, which is part of the isolation circuit 4. Finally, it is provided that the analog outputs 12 of the measuring device 1 are galvanically decoupled from one another via an optocoupler 41.

Decisive for the present invention is the low-inductance coupling of the shieldings 21 of the sensor signal lines 20 to the housing 14, as well as the galvanic decoupling of all circuit portions 12, 15, 16, 19 of the measuring device 1. Overall, this provides an especially robust measuring device 1 for liquid and/or gas analysis, a device that is insensitive to interferences. In this way, a markedly improved accuracy and reliability of the measuring results are achieved.

1-7. (canceled)

8. A measuring device for the conditioning, output and forwarding of sensor signals in the context of a liquid and/or gas analysis, comprising:
a housing of an electrically conductive material;
at least one cable gland in the wall of said housing for a shielded sensor signal line for the transmission of the sensor signals; and
an electrically conductive connection between a shielding of said sensor signal line and said housing, wherein:
said at least one cable gland has regions of an electrically conductive material and means for the electrical contacting of said regions both with said shielding of said sensor signal line and with said housing; and
said regions serve for creating an electrically conductive connection between said shielding and said housing.

9. The measuring device as claimed in claim 8, wherein:
each cable gland has a body which comprises an electrically conductive material.

10. The measuring device as claimed in claim 8, further comprising:
a computing unit, especially a microprocessor, for processing the sensor signals and at least one sensor circuit arranged between said computing unit and said sensor signal line for the preprocessing of the sensor signals, wherein:
each sensor circuit is galvanically decoupled from the remainder of the measuring device.

11. The measuring device as claimed in claim 10, further comprising:
optocouplers for the galvanic decoupling of each of said sensor circuit from the remainder of the measuring device.

12. The measuring device as claimed in claim 8, further comprising:
at least one power supply circuit for the supply of each of said sensor circuit with energy, wherein:
said power supply circuit has means for decoupling the measuring device from said power supply.

13. The measuring device as claimed in claim 12, wherein:
said means for decoupling are in the form of at least one transformer.

14. The measuring device as claimed in claim 8, further comprising:
at least two analog outputs, wherein:
said analog outputs are galvanically decoupled from one another.
